(19) United States
(12) Patent Application Publication
(10) Pub. No.: US 2025/0249474 A1
(43) Pub. Date: Aug. 7, 2025

(54) OPERATING METHOD FOR A COATING SYSTEM AND CORRESPONDING COATING SYSTEM

(71) Applicant: Dürr Systems AG, Bietigheim-Bissingen (DE)

(72) Inventors: Michael Zabel, Winnenden (DE); Ralph Glaser, Schömberg (DE)

(21) Appl. No.: 18/854,910

(22) PCT Filed: Apr. 3, 2023
(86) PCT No.: PCT/EP2023/058671

§ 371 Date: Oct. 7, 2024

(30) Foreign Application Priority Data
Apr. 8, 2022 (DE) 10 2022 108 537.6

(51) Int. Cl. B05B 15/555; B05B 12/00; B05B 16/40; B08B 3/14

(52) U.S. Cl. CPC B05B 15/555; B05B 12/004; B05B 16/40; B08B 3/14

(57) ABSTRACT

An operating method for a coating installation for coating components (e.g. motor vehicle body components) with a coating agent (e.g. paint) including:
rinsing at least one component of the coating installation with a rinsing agent for rinsing out the coating agent remaining in or on the rinsed component, collecting a rinsing agent mixture of the rinsing agent applied for rinsing and residues of the rinsed-out coating agent, and measuring the collected rinsing agent mixture and determining a measurement result according to the measurement.

### CROSS-REFERENCE TO RELATED APPLICATIONS

This application is a national stage of, and claims priority to, Patent Cooperation Treaty Application No. PCT/EP2023/058671, filed on Apr. 3, 2023, which application claims priority to German Application No. DE 10 2022 108 537.6, filed on Apr. 8, 2022, which applications are hereby incorporated herein by reference in their entireties.

### FIELD

The disclosure relates to an operating method for a coating installation for coating components with a coating agent, in particular for a painting installation for painting motor vehicle body components with a paint. The disclosure also relates to a coating installation for carrying out the operating method according to the disclosure.

### BACKGROUND

In modern paint shops for painting vehicle body components, rotary atomizers are usually used as application devices. These rotary atomizers have to be cleaned occasionally, especially when changing paint. For this purpose, the rotary atomizers are usually inserted into a cleaning device by a painting robot, as is known from EP 1 671 706 A2, for example. In the cleaning device, the rotary atomizer to be cleaned is then sprayed from the outside with a rinsing agent in order to clean the outer surfaces of the rotary atomizer. In addition, a rinsing agent also flows through the rotary atomizer to be cleaned in the cleaning device in order to rinse out paint residues from the rotary atomizer. This cleaning process produces a rinsing agent mixture including the rinsing agent used and paint residue. This rinsing agent mixture is usually collected and disposed of.

The problem here is the assessment of the rinsing quality, which should be checked when a painting booth is commissioned and also during operation. Until now, this has required entering the painting booth and visually inspecting the cleaning result on the rotary atomizer. The disadvantage of the known cleaning process is therefore the fact that the painting booth has to be entered to check the cleaning result.

Reference should also be made to DE 10 2010 041 930 A1, DE 103 16 644 A1, DE 10 2005 049 227 A1, EP 1 346 777 A2, DE 11 2019 002 282 T5, US 2010/0 047 465 A1 and DE 43 42 128 A1. Some of these publications disclose coating installations in which the rinsing agent mixture is collected and filtered. The filtrate of the rinsing agent mixture is then measured in order to draw conclusions about the previous rinsing process. In this state of the art, therefore, it is not the rinsing agent mixture itself that is measured, but the filtrate obtained from it. However, this is associated with various disadvantages. Firstly, this technique is relatively time-consuming, as the rinsing agent mixture should first be filtered before the filtrate can be analyzed. Secondly, this technique does not enable real-time measurement, as the filtrate is only measured with a time delay. A further disadvantage of this technique is that the filters used have to be disposed of as waste.

### BRIEF DESCRIPTION OF THE DRAWINGS

FIG. 1 shows a schematic representation of a painting installation according to the disclosed technology with a cleaning device.

FIG. 2A shows a schematic representation of the measuring devices for measuring the rinsing agent mixture.

FIG. 2B shows a schematic representation of parts of the collecting device and the measuring device.

FIG. 2C shows a reference spectrum for a perfect rinsing result.

FIGS. 3A-3C show corresponding representations for a real measurement on a rinsing agent mixture, where the rinsing result is not perfect but still acceptable.

FIG. 4 shows a spectrum measured on a rinsing agent mixture, where the spectrum indicates an unacceptable rinsing result.

FIG. 5 shows a flow chart illustrating the operating method according to the disclosed technology.

FIG. 6 shows a modification of FIG. 1.

### DETAILED DESCRIPTION

The disclosed technology is based on the task of specifying a correspondingly improved operating method and creating a coating installation which is suitable for carrying out the operating method according to the disclosure.

The operating method according to the disclosure relates to a coating installation for coating components with a coating agent. In an embodiment of the disclosure, the coating installation is a painting installation for painting motor vehicle body components with a paint. However, the disclosure is not limited to paints with regard to the coating agent to be applied, but can also be realized with other types of coating agents, such as insulating materials, sealants, adhesives, to name just a few examples. Furthermore, the disclosure is also not limited to motor vehicle body components with regard to the components to be coated. Furthermore, the disclosure is also not limited to the rinsing and cleaning of a rotary atomizer or other applicator (e.g. print head). The operating method according to the disclosure is therefore generally suitable for rinsing components of a coating installation.

The operating method according to the disclosure also provides for at least one component (e.g. rotary atomizer) of the coating installation to be rinsed with a rinsing agent in order to rinse out coating agent residues remaining in the component or to rinse off coating agent residues adhering to the component. The disclosure thus includes both internal rinsing and external rinsing, whereby both variants (internal rinsing and external rinsing) are also possible on their own.

In addition, the operating method according to the disclosure provides that a rinsing agent mixture is collected during a rinsing process, which includes the rinsing agent applied for rinsing on the one hand and residues of the rinsed-out coating agent (e.g. paint residues) on the other hand.

The operating method according to the disclosure is now characterized by the fact that the collected rinsing agent mixture is measured, whereby a measurement result is determined, which then enables a quality assessment in a next step in order to be able to assess the rinsing quality of the previous rinsing process. Thus, if the rinsing process is inadequate, the collected rinsing agent mixture still contains relatively large quantities of paint residues at the end of the rinsing process, which can be detected by measuring the rinsing agent mixture in accordance with the disclosure. In such a case, the duration of the rinsing process can then be extended, for example, so that at the end of the rinsing process only an acceptably small amount of paint residue is still present in the rinsing agent mixture.

On the one hand, the disclosure offers the advantage that it is no longer necessary to enter the painting booth in order to be able to assess the rinsing quality of a rinsing process by means of a visual inspection of the component to be cleaned (e.g. rotary atomizer). On the other hand, the disclosure also enables automated checking of the rinsing quality, which is much more accurate and largely eliminates human error.

In an embodiment of the disclosure, rinsing takes place according to a predetermined rinsing program, whereby the rinsing program determines at least one rinsing parameter, such as the rinsing duration. As part of the operating method according to the disclosure, the rinsing program is then adapted if the quality assessment of the measurement result on the collected rinsing agent mixture shows an insufficient rinsing quality. For example, the rinsing time can be extended for this purpose. However, the disclosure is not limited to the rinsing time with regard to the rinsing parameter to be adjusted. For example, the rinsing agent pressure or the rinsing agent flow can also be adjusted, to name just two examples.

The aforementioned adjustment of the rinsing program depending on the quality assessment of the rinsing process can be carried out manually by an operator, for example. If, for example, the quality assessment comes to the conclusion that the previous rinsing process was unsatisfactory, the user can move a slider on a control unit or in a graphical user interface of an operating computer and thereby adjust the rinsing parameter to be adapted (e.g. rinsing time).

Alternatively, it is also possible for the rinsing program to be adjusted automatically as part of a control loop depending on the quality assessment.

It has already been briefly mentioned above that the collected rinsing agent mixture is measured in order to enable a quality assessment. With regard to this measurement, there are various possibilities within the scope of the disclosure, which are briefly described below.

In an embodiment of the disclosure, the collected rinsing agent mixture is measured optically, by transmission measurement, i.e. the collected rinsing agent mixture is transilluminated and the light transmitted by the rinsing agent mixture is measured. Alternatively, an optical measurement can also be a reflection measurement on the collected rinsing agent mixture, i.e. the reflected light is measured.

In an optical measurement, it is generally possible to use infrared light, ultraviolet light or light in the nonvisible wavelength range. Alternatively, however, it is also possible within the scope of the disclosure for light in the visible wavelength range to be used for the optical measurement of the collected rinsing agent mixture.

With regard to the optical measurement of the collected rinsing agent mixture, it should also be mentioned that a spectral measurement is used.

It should also be mentioned that the collected rinsing agent mixture can also be measured by nephelometry.

Alternatively, it is also possible to measure the pH value or the electrical conductivity of the rinsing agent mixture when measuring the collected rinsing agent mixture.

Furthermore, a gravimetric or volumetric measuring method can also be used.

In addition, it is also possible to measure the collected rinsing agent mixture acoustically, for example by measuring the transit time of an acoustic signal in the collected rinsing agent mixture.

Finally, it is also possible to perform a sedimentation analysis on the collected rinsing agent mixture, in particular by means of a precipitation analysis.

The above examples of measurement methods are not exhaustive, i.e. other measurement methods can also be used within the scope of the disclosure to measure the collected rinsing agent mixture.

In the operating method according to the disclosure, the rinsing and the quality assessment of the rinsing can, for example, be requested manually by an operator. Alternatively, however, it is also possible for the rinsing and the quality assessment of the rinsing to be requested by a computerized maintenance assistant, which generates a corresponding maintenance request. In addition, it can be useful to carry out the flushing and the quality assessment of the flushing when a pump test is carried out, in particular when testing the dosing accuracy of a pump. Furthermore, it can be advantageous to perform the rinsing and quality assessment of the rinsing when a coating batch is changed, when the coating formulation is changed or when the proportion of a certain color in the total color volume is changed.

In general, it should also be mentioned that the application device (e.g. rotary atomizer) is guided by a coating robot, whereby the coating robot moves the application device to a certain predetermined rinsing position for rinsing and measuring the collected rinsing agent mixture.

For example, this rinsing position can be located in a cut-out in a booth wall of a coating booth.

Alternatively, it is possible that at least one maintenance booth (“cubicle”) is arranged in the coating booth, as is known from DE 10 2021133 410.1, for example. The rinsing position can then be located in a cut-out in the booth wall of the maintenance booth.

The aforementioned cut-out in the booth wall of the coating booth or the maintenance booth can be closed by a closure when no rinsing takes place.

The disclosure does not only claim protection for the operating method according to the disclosure described above. Rather, the disclosure also claims protection for a corresponding coating installation which is suitable for carrying out the operating method according to the disclosure.

For this purpose, the coating installation according to the disclosure firstly includes an application device for applying the coating agent, such as a rotary atomizer.

In addition, the coating installation according to the disclosure also includes a coating agent supply in order to supply the application device (e.g. rotary atomizer) with the coating agent to be applied.

The coating installation according to the disclosure also includes a rinsing device for rinsing the application device and/or the coating agent supply with a rinsing agent in order to rinse out or rinse off residues of the coating agent.

In addition, the coating installation according to the disclosure also includes a collecting device for collecting the rinsing agent mixture during a rinsing process.

The coating installation according to the disclosure is now characterized by a measuring device which is suitable for measuring the collected rinsing agent mixture and generating a corresponding measurement result. This measurement result can then be used to evaluate the rinsing quality of the previous rinse.

It should be mentioned here that the collecting device and the measuring device can be integrated together in one component. Alternatively, however, it is also possible for the collecting device and the measuring device to be separate components.

In an embodiment of the disclosure, the application device (e.g. rotary atomizer) is arranged in a coating booth, whereby the application device can, for example, be guided by a coating robot. The collecting device for collecting the rinsing agent mixture has a collecting container which is arranged inside the coating booth. The measuring device, on the other hand, can be arranged outside the coating booth and is then connected to the collection container inside the coating booth via a liquid line.

The collection device for the rinsing agent mixture can, for example, have one or more of the following components, which are arranged one behind the other in the direction of flow:
A rinsing agent collection cascade for the forced collection of the rinsing agent mixture,
a droplet separator for separating and collecting rinsing agent droplets,
a funnel that leads into the measuring device,
a rinsing agent supply to the funnel for rinsing the funnel with a rinsing agent, in particular with a hose for supplying the lubricant, and
a shut-off valve between the collecting device and the measuring device.

The actual measuring device, on the other hand, can contain one or more of the following components, for example:
A measuring cell for holding the rinsing agent mixture during measurement,
a light source for illuminating the measuring cell with the rinsing agent mixture contained therein,
a light detector for detecting the light emitted by the light source after the measuring cell has been illuminated with the rinsing agent mixture contained therein.

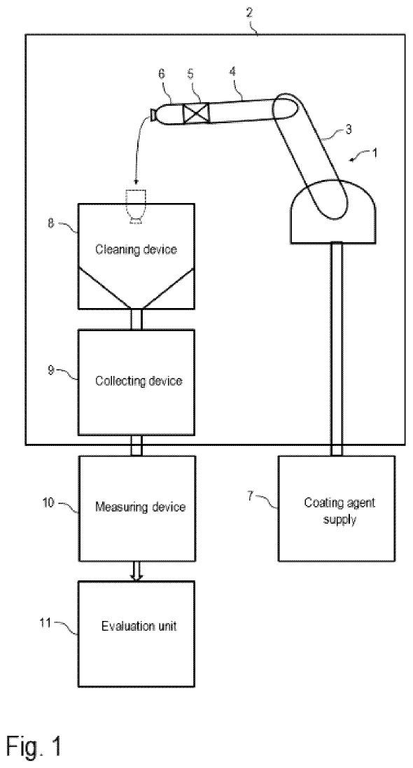

FIG. 1 shows a schematic representation of a painting installation according to the disclosed technology.

Thus, the painting installation according to the disclosed technology initially includes a painting robot 1 which is arranged in a painting booth 2, the painting robot 1 being shown here only schematically and having a proximal robot arm 3 (“arm 1”) and a distal robot arm 4 (“arm 2”), the two robot arms 3, 4 being pivotable relative to one another. At the end of the robot arm 4 there is a robot hand axis 5, which ultimately carries a rotary atomizer 6.

The rotary atomizer 6 is supplied with the media required for operation, such as paint and rinsing agent, by a coating agent supply 7, which is only shown schematically.

The painting booth 2 also contains a cleaning device 8, which can be of largely conventional design, as is known, for example, from EP 1 671 706 A2. To clean the rotary atomizer 6, the painting robot 1 inserts the rotary atomizer 6 into the cleaning device 8 through an insertion opening in the cleaning device 8. The rotary atomizer 6 is then sprayed on the outside with a rinsing agent in the cleaning device 8 and also rinsed on the inside with rinsing agent.

The rinsing agent mixture of the rinsing agent and the rinsed-out paint residues produced during such a rinsing process is then collected by a collecting device 9, which is also located in the painting booth 2.

The collected rinsing agent mixture is then passed from the collecting device 9 to a measuring device 10 located outside the painting booth 2, which measures the rinsing agent mixture in order to enable a quality assessment of the rinsing process.

The measuring device 10 then forwards a corresponding measurement result to an evaluation unit 11, which uses the measurement result to assess the rinsing quality of the rinsing process.

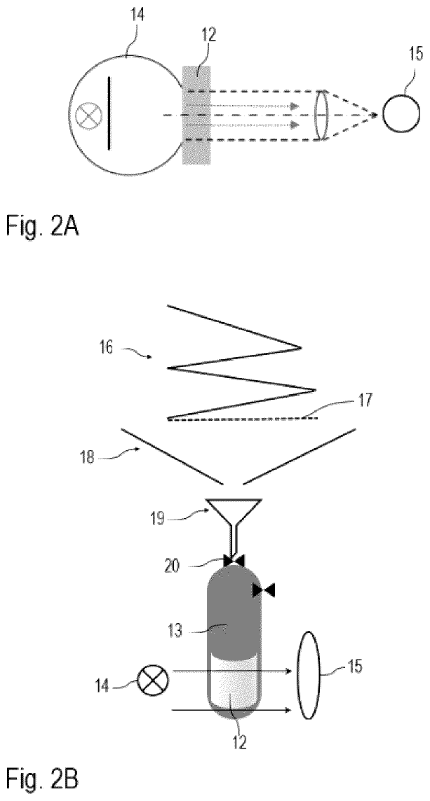

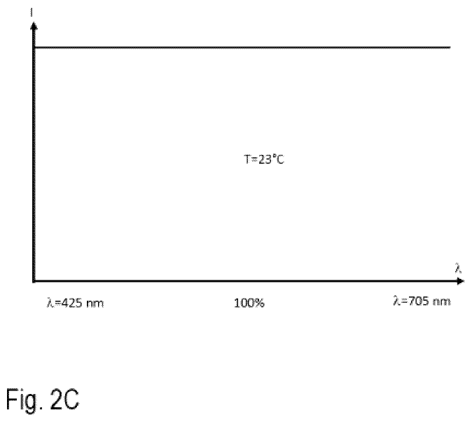

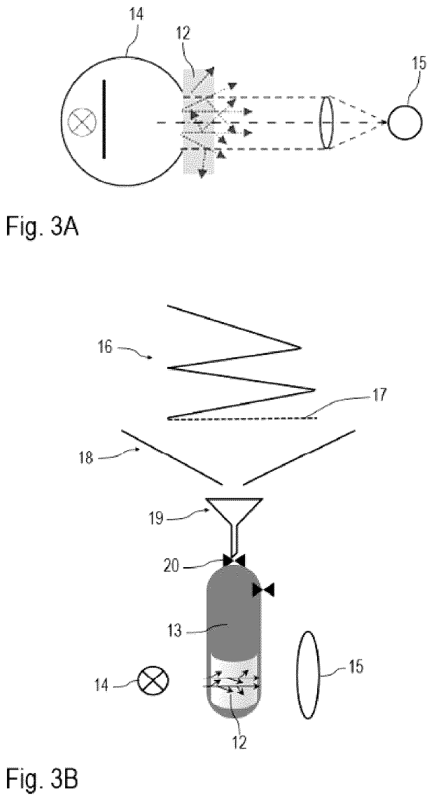

FIG. 2A shows a schematic representation of part of the measuring device 10, wherein the measuring device 10 operates optically in this embodiment and carries out an optical transmission measurement on a rinsing agent mixture 12, which is located in a measuring cell 13 for this purpose.

For this purpose, the measuring device 10 includes a light source 14 to illuminate the rinsing agent mixture 12. In addition, the measuring device 10 includes a light detector 15 in order to spectrally measure the light transmitted by the rinsing agent mixture 12 during a transmission measurement.

FIG. 2B also shows components of the collecting device 9, namely a rinsing agent collecting cascade 16 for the forced collection of the rinsing agent mixture 12, a droplet separator 17 for separating and collecting rinsing agent droplets, a rinsing agent supply 18 and a funnel 19. Furthermore, a shut-off valve 20 is provided between the funnel 19 and the measuring cell 13.

FIG. 2C shows an idealized spectrum I measured by the light detector 15 during a perfect rinsing process.

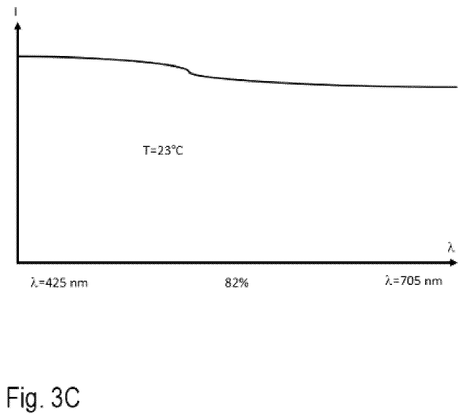

FIG. 3C shows a real measured spectrum I, which was measured on the rinsing agent mixture 12 and indicates a still acceptable rinsing result.

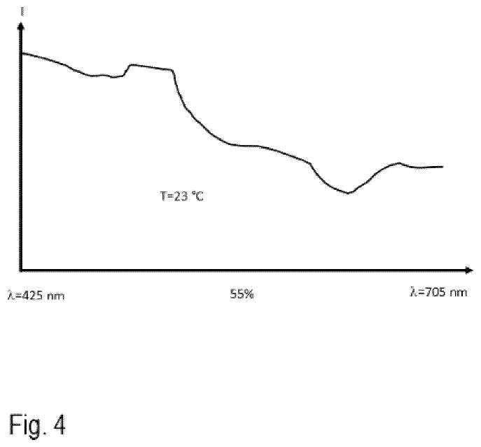

FIG. 4 shows a spectrum I, also measured in real terms, which was measured on the collected rinsing agent mixture 12 and indicates an unacceptable rinsing result.

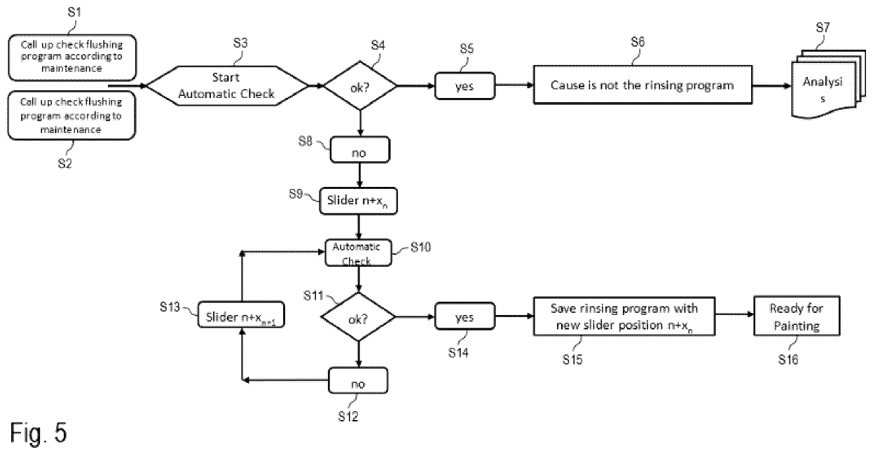

The flow chart according to FIG. 5, which explains the operating method according to the disclosed technology, is now described below.

First of all, the flow chart provides for a call to check the flushing program in steps S1 and S2. This can follow in step S1, for example, if a check of the rinsing program is required according to the maintenance program. Alternatively, the rinsing result can also be checked in step S2 in the event of a color carryover.

In the next step S3, the automatic test program is then started, in which the collected rinsing agent mixture is measured and qualitatively evaluated, which is provided for in step S4.

If the quality assessment in step S4 shows that the rinsing result is acceptable, this is determined in step S5 and it is recorded in step S6 that there is no cause for a fault in the rinsing program.

The measurement result can then be analyzed in a further step S7.

If, on the other hand, checking the quality of the rinsing process in step S4 shows that the rinsing result is unsatisfactory, this is determined in step S8 and a rinsing parameter (e.g. rinsing duration) is adjusted in step S9.

In the next step S10, the quality of the rinsing process is automatically checked again by measuring the collected rinsing agent mixture.

Step S11 checks whether the rinsing quality is acceptable.

If the rinsing quality is not acceptable, this is determined in a step S12 and the rinsing parameters (e.g. rinsing time) are then adjusted in an optimization loop in a step S13 until the automatic check of the rinsing quality produces a satisfactory result.

If the result is satisfactory, this is determined in step S14 and the optimized value of the rinsing parameter (e.g. rinsing duration) is saved in step S15 for the subsequent rinsing processes.

In the next step S16, the coating installation is then ready for operation.

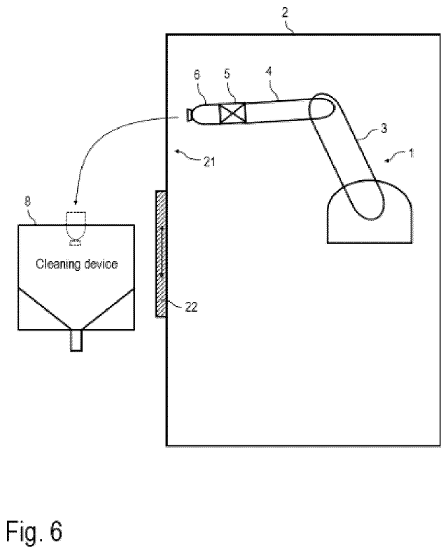

Finally, FIG. 6 shows a modification of the illustration according to FIG. 1, so that reference is made to the above description to avoid repetition, whereby the same reference signs are used for corresponding details.

A special feature here is that the cleaning device 8 is located outside the painting booth 2. To clean the rotary atomizer 6, the painting robot 1 moves the rotary atomizer 6 through an opening 21 in the wall of the painting booth 2, so that the rotary atomizer 6 can then be inserted into the cleaning device 8 located outside the painting booth 2.

The opening 21 in the wall of the painting booth 2 can be closed by a closure 22, whereby the closure 22 is only shown schematically.

1.-16. (canceled)

17. A method for coating components with a coating agent, the method comprising:
a) rinsing at least one component of a coating installation with a rinsing agent for rinsing out coating agent remaining in or on the rinsed component,
b) collecting a rinsing agent mixture of the rinsing agent applied for rinsing and residues of the rinsed-out coating agent, and
c) measuring the collected rinsing agent mixture and determining a measurement result corresponding to the measurement.

18. The method according to claim 17, further comprising:
performing a quality assessment of the measurement result for assessing the rinsing quality of the preceding rinsing.

19. The method according to claim 17, wherein
a) the rinsing is carried out in accordance with a predetermined rinsing program, the rinsing program determining at least one rinsing parameter, and
b) the rinsing program is adapted if the quality assessment of the measurement result shows an insufficient rinsing quality.

20. The method according to claim 19, wherein the adjustment of the rinsing program takes place as a function of the quality assessment manually by an operator.

21. The method according to claim 19, wherein the adjustment of the rinsing program takes place as a function of the quality assessment automatically as part of a control loop.

22. The method according to claim 17, wherein the measurement of the collected rinsing agent mixture is carried out using at least one of the following measuring methods:
a) an optical measurement of the collected rinsing agent mixture,
b) a measurement of the pH value of the rinsing agent mixture,
c) a measurement of the electrical conductivity of the rinsing agent mixture,
d) a gravimetric measuring method,
e) a volumetric measurement method,
f) acoustically by a transit time measurement of an acoustic signal,
g) sedimentation analysis.

23. The method according to claim 17, wherein the rinsing and the quality assessment of the rinsing are carried out in response to at least one of the following events:
a) upon a maintenance request by a computerized maintenance assistant,
b) during an evaluation of a pump test,
c) when the coating agent batch is changed,
d) when the coating agent recipe is changed,
e) a change in the proportion of a particular color in the total color volume.

24. The method according to claim 17, wherein
a) the component to be rinsed is an application device which is guided by a coating robot, and
b) the coating robot moves the application device into a rinsing position for rinsing and for measuring the collected rinsing agent mixture.

25. The method according to claim 24, wherein
a) the coating robot with the application device is arranged in a coating booth which at least partially has a closed booth wall, and
b) the rinsing position is located in a cut-out in the booth wall of the coating booth.

26. The method according to claim 24, wherein
a) the coating robot with the application device is arranged in a coating booth which has at least partially a closed booth wall,
b) a maintenance booth is arranged in the coating booth, which at least partially has a closed booth wall, and
c) the rinsing position is located in a cut-out in the booth wall of the maintenance booth.

27. The method according to claim 25, wherein
a) the cut-out in the booth wall is opened by a closure for rinsing the application device,
b) the cut-out in the booth wall is closed by the closure after the application device has been rinsed.

28. A coating installation for coating components with a coating agent, comprising:
a) an application device for applying the coating agent,
b) a coating agent supply for supplying the application device with the coating agent to be applied,
c) a rinsing device for rinsing the application device and/or the coating agent supply with a rinsing agent for rinsing out residues of the coating agent which have remained on or in the application device and/or the coating agent supply after an application process,
d) a collecting device for collecting a rinsing agent mixture of the rinsing agent applied by the rinsing device for rinsing and residues of the rinsed-out coating agent, and
e) a measuring device for measuring the collected rinsing agent mixture and for determining a measurement result corresponding to the measurement.

29. The coating installation according to claim 28, further comprising an evaluation unit for evaluating the quality of the measurement result for assessing the rinsing quality of the preceding rinsing.

30. The coating installation according to claim 28, wherein the collecting device and the measuring device are integrated together in one component.

31. The coating installation according to claim 28, wherein the collecting device and the measuring device are separate components.

32. The coating installation according to claim 28, wherein
a) the application device is arranged in a coating booth,
b) the collecting device for collecting the rinsing agent mixture has a collecting container which is arranged inside the coating booth,
c) the measuring device is arranged outside the coating booth, and
d) the collecting container inside the coating booth is connected to the measuring device outside the coating booth by a liquid line.

33. The coating installation according to claim 28, wherein the collecting device comprises:
a) a rinsing agent collecting cascade for the forcibly guided collection of the rinsing agent mixture,
b) a drop separator for separating and collecting drops of rinsing agent,
c) a funnel which leads into the measuring device,
d) a rinsing agent supply to the funnel for rinsing the funnel with a rinsing agent, and
e) a shut-off valve between the collecting device and the measuring device.

34. The coating installation according to claim 28, wherein the measuring device comprises:
a) a measuring cell for receiving the rinsing agent mixture during the measurement,
b) a light source for illuminating the measuring cell with the rinsing agent mixture contained therein, and
c) a light detector for detecting the light emitted by the light source after the measuring cell has been illuminated with the rinsing agent mixture contained therein.
